(19) United States
(12) Patent Application Publication
(10) Pub. No.: US 2024/0237641 A1
(43) Pub. Date: Jul. 18, 2024

(54) COMPOSITION COMPRISING GRAPHENE FOR THE TREATMENT OF TEXTILE ARTICLES AND TEXTILE ARTICLES TREATED

(71) Applicant: DIRECTA PLUS S.P.A., Lomazzo (CO) (IT)

(72) Inventors: Laura Giorgia Rizzi, Saronno (IT); Giulio Cesareo, Como (IT)

(21) Appl. No.: 18/289,378

(22) PCT Filed: May 3, 2022
(86) PCT No.: PCT/EP2022/061779

§ 371 Date: Nov. 3, 2023

(30) Foreign Application Priority Data
May 4, 2021 (IT) 102021000011381

(51) Int. Cl. A01N 25/34; A01N 25/24; A01N 35/02; A01N 35/06; A01N 43/16; A01P 1/00; D06M 11/74; D06M 13/175; D06M 15/03; D06M 15/11; D06M 15/13; D06M 16/00; D06M 101/30

(52) U.S. Cl. CPC A01N 25/34; A01N 25/24; A01N 35/02; A01N 35/06; A01N 43/16; A01P 1/00; D06M 11/74; D06M 13/175; D06M 15/03; D06M 15/11; D06M 15/13; D06M 16/00; D06M 2101/30

(57) ABSTRACT

Composition for the treatment of textile articles comprising graphene and a binder agent dispersed in an aqueous medium, in which the binder agent is a polysaccharide selected from the group consisting of starch, glycogen, chitosan, pectin, salts of alginic acid or alginates, dextran, chitin, and glycans, and textile article treated with said composition.

The present invention relates to a composition comprising graphene for the treatment of textile articles and the textile articles treated with said composition.

### BACKGROUND OF THE INVENTION

It is known to treat textile articles with graphene for the purpose of conferring high properties of electrical and/or thermal conductivity upon them, due to the high electrical and/or thermal conductivity of the graphene.

In the field of textile articles, a particular sector is formed by filtering articles, which can be used in various industry sectors, such as the sector of filters for air conditioning systems or exhaust hoods, both for industrial and domestic use, and filters used in the air conditioning systems of motor vehicles. Other examples of filtering articles are those destined for personal health protection, such as face masks and the like.

For the purposes of the present invention textile articles that are used in the clothing and furnishing sectors, the latter also including sofas, armchairs and seats with textile coverings, are also of particular interest.

In all these sectors of use graphene is of great interest as it allows an increase in the filtering effect relative to dusts, fumes and aerosols normally exhibited by the textile article, and also a counteraction to be carried out with respect to pathogenic microorganisms such as bacteria, fungi and viruses. In this regard, the recent SARS-CoV-2 pandemic has brought to light the need for new types of face masks adapted to ensure a high level of protection not only with respect to atmospheric particulate but also to pathogens.

However, the application of graphene to the textile article requires it to be formulated in a liquid or paste composition suitable for the treatment of textile articles with known techniques such as printing or impregnation, and for this composition to include at least one binder adapted to fix the graphene to the textile matrix.

Therefore, compositions are known in which the graphene is dispersed in a liquid medium, which can be water or an organic solvent, in the presence of at least one binder and often of a surfactant. Typically, the binder consists of a synthetic polymer, for example polyurethane, polyacrylate, polybutadiene and the like. After the dispersant liquid medium has been removed from the textile article treated with the aforesaid composition, the binder is the quantitatively most relevant component deposited thereon.

However, the use of synthetic polymers, which derive from fossil, and hence non-renewable, raw materials, is not desirable from the point of view of environmental sustainability.

GB 2526591 A describes a conductive ink comprising at least one solvent, at least one binder and a conductive material selected from metals, such as powdered or flaked gold, silver and copper, or from a family of substances consisting of various forms of carbon, among which graphite, activated carbon, graphene, carbon nanotubes, carbon fibers and others are cited. The preferred binder is natural latex, but other possible binders are mentioned, such as starch, dextrin, asphalts, plant resins such as copal, shellac, rosin and derivatives thereof. GB 2526591 A does not mention the application of conductive ink to textile articles and/or filtering elements.

CA 3 097 636 A1 discloses viral active and/or anti-microbial inks and coatings containing graphene and/or graphene oxide particles dispersed in a carrier. Typically, the graphene particles are functionalized with oxygen-containing functional groups, and have an oxygen content of from 10 to 30%. Typically, the ink contains also metal ions or metal nanoparticles. The ink may be a paste containing a binder selected form cellulose derivatives and synthetic polymers.

Therefore, there is the need for new compositions comprising graphene for the treatment of textile articles, which does not use components of fossil origin, hence deriving from crude oil, which have a negative impact on the environment.

More in particular, there is the need for new compositions comprising graphene for the treatment of textile articles, in which only components prepared from raw materials obtained from renewable sources, such as raw materials of plant origin, are used for the production of textile articles destined for clothing or for contact with the human body of for the production of filtering manufactured products, both for civil or industrial use and for personal health protection.

### SUMMARY OF THE INVENTION

Therefore, an object of the present invention is to provide a composition for the treatment of textile articles that comprises graphene and the other components consist of or derive from raw materials obtained from renewable and environmentally sustainable sources.

Another object of the invention is to provide a composition of this kind for the treatment of textile articles that can be advantageously used in the production of articles of clothing or manufactured products destined for contact with the human body or for the production of filtering manufactured products, both for civil and industrial use.

A further object of the invention is to provide a textile article for personal health protection, such as face masks and the like.

Therefore, an aspect of the present invention relates to a composition for the treatment of textile articles comprising graphene and a binder agent dispersed in an aqueous medium, characterized in that said binding agent is a polysaccharide.

Another aspect of the invention relates to a textile article, characterized in that it comprises graphene in an amount from 0.5 a 20 g per square meter of textile substrate, and a binder consisting of a polysaccharide in an amount from 0.5 a 50 g per square meter of textile substrate.

A further aspect of the invention concerns a composition for the treatment of textile articles comprising graphene and a binder agent dispersed in an aqueous medium, characterized in that said binder agent is a polysaccharide, and in that said composition also comprises a natural phytotherapeutic substance with an inhibitory effect on SARS-CoV-2 infection.

Yet another aspect of the invention consists of a filtering textile article, characterized in that it comprises graphene in an amount from 0.5 a 20 g of graphene per square meter of textile substrate, a binder consisting of a polysaccharide in an amount from 0.5 to 50 g per square meter of textile substrate, and a natural phytotherapeutic substance with an inhibitory effect on SARS-CoV-2 infection.

### BRIEF DESCRIPTION OF THE DRAWINGS

FIGS. 1A and 1B show a textile article printed on one side with a hexagonal pattern with a composition according to the invention; and

FIGS. 2 and 3 show textile articles printed on the whole of the surface of one side with compositions according to the invention.

### DESCRIPTION OF THE INVENTION

According to the present invention, the term “textile substrate” or “textile article” is meant as a substantially flat substrate selected from the group consisting of fabrics, nonwovens, felts, films, polymeric membranes and expanded foams. The term also includes the combination of one or more of said substrates.

With regard to the fabric, it can be manufactured in natural, artificial or synthetic fiber. With regard to the nonwoven, film, polymeric membrane, felts and expanded foams, these are typically manufactured with artificial fibers or synthetic resins.

The composition for the treatment of textile articles according to the invention comprises graphene and a binder agent consisting of one or more polysaccharides dispersed in an aqueous medium, in which the polysaccharide is present in an amount by weight higher than the amount of graphene.

The composition is preferably in liquid or paste form, where the liquid is water or an aqueous medium.

The polysaccharide is preferably selected from the group consisting of starch, glycogen, chitosan, pectin, salts of alginic acid or alginates, dextran, chitin, glycans.

More preferably the polysaccharide is selected from the group consisting of starch, chitosan, pectin, sodium alginate.

The starch is preferably selected from corn starch, potato starch, tapioca starch, rice starch and pea starch.

The graphene preferably comprises graphene nano-platelets in which at least 90% has a lateral dimension (x, y) from 100 to 50000 nm and a thickness (z) from 0.34 to 50 nm.

According to a further aspect, the graphene preferably comprises graphene nano-platelets in which the C/O ratio is ≥100:1.

In an embodiment, at least 90% of the graphene nano-platelets has a lateral dimension (x, y) from 200 to 10000 nm and a thickness (z) from 0.34 to 10 nm, more preferably a lateral dimension (x, y) from 400 to 8000 nm, even more preferably between 500 and 5000 nm.

In an embodiment, at least 90% of the graphene nano-platelets has a thickness (z) from 0.34 to 8 nm, more preferably from 0.34 to 5 nm.

In an embodiment, the composition for the treatment of textile articles is an aqueous dispersion which comprises:
a) from 0.5 to 20% by weight of graphene;
b) from 1.0 to 50% by weight of polysaccharide.

The viscosity of the composition is in the range from 800 to 120000 cPs (from 0.8 to 120 Pa·s) and is mainly regulated by the amount of polysaccharide binder.

The viscosity is measured according to the standard ISO 2555/1652 using a Fungilab series Viscolead PRO rotational viscometer, R6 spindle speed 10 rpm, T=20° C.

The viscosity of the composition is preferably in the range from 100 to 100000 cPs, or from 10 to 100 Pa·s.

In an embodiment, the composition for the treatment of textile articles is an aqueous dispersion which comprises:
a) from 1.0 to 16% by weight of graphene;
b) from 1.5 to 30% by weight of polysaccharide.

In a preferred embodiment, the composition comprises from 1.5 to 15% by weight of graphene.

In a preferred embodiment, to confer high properties of electrical conductivity upon the textile article, the composition comprises from 2.0 to 15% by weight of graphene.

In a preferred embodiment, the composition comprises from 2.0 to 20% by weight of polysaccharide, more preferably from 2.5 to 15% by weight of polysaccharide.

In a preferred embodiment, the composition does not comprise metal ions or metal particles having an anti-viral or anti-microbial effect. In particular, the composition does not comprise metal ions or metal particles belonging to transition metals, more particularly ions of particles of Cu, Zn, Ag, Au.

In a preferred embodiment, the composition does not comprise binders different from polysaccharides.

According to an aspect of the present invention, the composition for the treatment of textile articles, and the textile articles thus treated, also comprise a natural phytotherapeutic substance with an inhibitory effect on SARS-CoV-2 infection.

In fact, it has surprisingly been found that the specific antiviral action of some natural phytotherapeutic substances against the SARS-CoV-2 virus can be added to the antibacterial and antiviral action exerted by the graphene deposited on the textile article.

Therefore, another aspect of the present invention concerns a composition for the treatment of textile articles, and the textile articles thus treated, which comprise a natural phytotherapeutic substance with an inhibitory effect on SARS-CoC-2 infection selected from the group consisting of curcumin, emodin, α-hederine and thymoquinone.

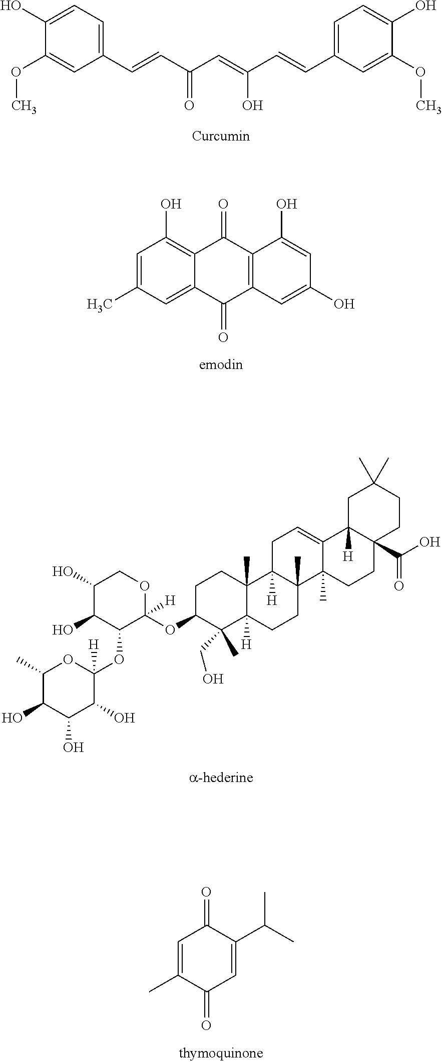

The aforesaid substances were selected as the subject of studies on molecular dynamics and sensitivity to various coronaviruses. In particular, tests were conducted on cytotoxicity and inhibition of SARS-CoV-2 infection, as briefly summarized below.

The substances were solubilized in dimethyl sulfoxide (DMSO) and renal epithelial cells (Vero E6 ATCC® CRL-1586™) were used for the test. The experimental procedure used was divided into 3 steps:
1) Evaluation of cytotoxicity (amount of dead cells) of DMSO on Vero E6 cells compared to the negative control, i.e., compared to Vero E6 cells not treated with DMSO;
2) Evaluation of cytotoxicity of the single substances dissolved in DMSO on Vero E6 cells compared to the negative control, i.e., compared to Vero E6 cells not treated with DMSO;
3) Evaluation of inhibition of the infection of Vero E6 cells by Sars-Cov-2 (around 10⁵ viral particles/mL) compared to the positive control, i.e., Vero E6 cells infected but not treated with any phytotherapeutic substance.

The results of the tests are as follows:

### 1) Cytotoxicity Test of DMSO

DMSO was administered to Vero E6 cells in different ratios with growth medium decreasing gradually towards lower concentrations. Cytotoxicity was evaluated using a luminescence kit for the quantification of viable cells and crystal violet colorimetric assay.

### 2) Cytotoxicity Test of Natural Phytotherapeutic Substances

The substances were administered to Vero E6 cells at different concentrations gradually decreasing towards lower concentrations. Cytotoxicity was evaluated using a luminescence kit for the quantification of viable cells. The analysis shows different concentrations tolerated by the cells, i.e.: for curcumin 0.015 mg/mL, for emodin 0.06 mg/mL, for α-hederine and thymoquinone 0.0075 mg/mL.

### 3) Test of Inhibition of Sars-CoV-2 Viral Infection

The natural substances were administered to Vero E6 cells previously infected with Sars CoV-2. The concentrations of substances were selected based on point (2), hence not cytotoxic per se for the cells. The substances were evaluated in the concentration ranges from 0.06 to 0.075 mg/mL. With the same concentration (0.015 mg/mL) maximum efficacy was obtained with Curcumin (94% viable cells), followed by Emodin (89% viable cells), α-Hederine (71% viable cells) and Thymoquinone (73% viable cells).

The tests thus proved the efficacy of curcumin, emodin, α-hederine and thymoquinone in the inhibition of Sars COV-2 infection.

Therefore, in an embodiment of the present invention, the composition for the treatment of textile articles is an aqueous dispersion which comprises:
a) from 0.5 to 20% by weight of graphene;
b) from 1.0 to 50% by weight of polysaccharide;
c) from 0.1 a 10% by weight of a natural phytotherapeutic substance with an inhibitory effect on SARS-CoC-2 infection selected from the group consisting of curcumin, emodin, α-hederine and thymoquinone.

Preferably, the natural phytotherapeutic substance is present in an amount from 0.5 a 5% by weight, more preferably between 1 and 4% by weight.

The textile article treated with the composition according to the present invention comprises a textile substrate selected from fabrics, nonwovens, felts, films, polymeric membranes and expanded foams, suitable for making both articles of clothing or furnishings such as curtains and of coverings for chairs, seats, sofas and the like, and for producing filtering elements, including manufactured products for personal health protection as provided with a certain filtering capacity and adapted to determine a relative low pressure drop when a fluid, for example air, passes through them. These manufactured products are thus breathable and adapted to permit normal breathing when the textile article is destined, for example, for form a face mask.

The pressure drop through the textile article and/or the manufactured product that incorporates it is measured as breathability according to the standard UNI EN 14683:2019.

According to the present invention, it is also possible to obtain a filtering textile article, treated with the composition according to the present invention, having a high bacterial filtration efficiency (“BFE”) according to the standard UNI EN 14683:2019, Annex B.

The application of the composition comprising graphene and a binder consisting of a polysaccharide, each present in an amount from 1 to 20 g/m², to textile substrates surprisingly gives the textile article thus obtained high filtering and antibacterial properties, defined by a bacterial filtration efficiency higher than 80%, measured according to the aforesaid method, while maintaining a breathability lower than 60 Pa/cm², measured according to the standard UNI EN 14683:2019.

Treatment of the textile article with a composition that, in addition to the graphene and to the binder, also contains one or more natural phytotherapeutic substances as described above also confers improved antiviral properties, in particular inhibitory properties against SARS-CoV-2 infection, upon the textile article.

Preferably, the textile article comprises graphene in an amount from 1 to 10 g of graphene per square meter of textile substrate, more preferably from 2 to 8 g of graphene per square meter of textile substrate.

When the composition for the treatment of textile articles comprises an amount of graphene higher than 1.5% by weight, its application on the textile article decreases the surface resistivity thereof.

It must be borne in mind that the textile substrates defined above consist of isolating materials, i.e., with a surface resistivity higher than 1·10¹¹Ω measured according to the standard JIS K 7194. The table below shows the classification of the materials according to their surface resistivity:

| | | Surface resistivity |
|---|---|---|
| Classification | Description of the property | (Ω/□) |
| Isolating material | Non-conductive material | ≥10¹¹ |
| Antistatic material | Inhibits triboelectric charges | 10⁸ ≤ × ≤ 10¹¹ |
| | (static electricity) and the | |
| | effects of generating the | |
| | charge | |
| Static dissipative | Dissipative of electrostatic | 10⁵ ≤ × ≤ 10⁸ |
| material | charges | |
| Conductive material | Heating materials | 10 ≤ × ≤ 10⁵ |
| Highly conductive | Shielding materials | ≤10 |
| material | | |

In particular, the textile article treated with the composition according to the invention can become from antistatic to conductive, according to the properties of the material and of the composition, as can be seen from the examples, which are part of this description.

With regard to the material of which the textile substrate, and hence the textile article, is made, it has been said that the fabric can be manufactured in natural, artificial or synthetic fiber.

Useful natural fibers include, for example, wool, silk and cotton. Useful artificial fibers include modified or regenerated cellulose fibers, such as viscose and cellulose acetate. Useful synthetic fibers comprise polyamide, including aromatic polyamides (aramids), polyester, polyurethane, polyacrylonitrile, polycarbonate, polypropylene, polyvinyl chlorine and their blends. Moreover, fabrics obtained from blends of natural, artificial and synthetic fibers can advantageously be used.

To produce a textile article that is completely environmentally sustainable, natural fibers are used.

With regard to the type of textile substrate, the following substrates can be used.

### Nonwoven:

Nonwovens used fall within the following categories:

### Spunlace

This is a nonwoven deriving from a process called hydroentangling. The process uses high pressure water jets that perforate the fabric and entangle the fibers giving the fabric greater substance. The consolidation of plies of fibers by means of high pressure water jets causes these to perforate the fabric and entangle the fibers without damaging them, as can occur with needle punching. Entangling of the fibers in various directions confers isotropic properties and the same strength in various directions upon the nonwoven.

### Spunbond

This is a nonwoven obtained by processing nonwoven synthetic fibers. The characteristic of this nonwoven is that of thermal point bonding of the fibers. This characteristic mechanically bonds the fibers to one another and imparts the “point bonding” characteristic, which is usually square or oval and makes the fabric both soft and strong.

### Felts

Another type of textile substrate that can be used is felt, consisting of synthetic fibers tangled and consolidated so as to form a compact structure using mechanical operations, as is known in the art.

Examples of synthetic felts are:
100% polyester 500 g/m²
100% polypropylene 450 g/m²
100% polyester 350 g/m²
100% polyester 340-380 g/m²

### Fabrics

These are textile substrates obtained by weaving yarns on a loom, as is known in the art.

### Other Textile Substrates

Expanded foams, breathable films and membranes, such as micro-perforated films and membranes, multi-ply structures composed of fabrics and membranes, bonded nonwoven and fabric structures.

### Graphene

With regard to graphene, it comprises, or consists of, graphene nano-platelets in which at least 90% have a lateral dimension (x, y) from 50 to 50000 nm and a thickness (z) from 0.34 to 50 nm. Preferably, at least 90% of the graphene nano-platelets have a lateral dimension (x, y) from 100 to 10000 nm and a thickness (z) from 0.34 to 10 nm. Preferably the C/O ratio is ≥ 100:1.

The scientific and patent literature describes various methods for the preparation of graphene, such as chemical vapor deposition, epitaxial growth, chemical exfoliation and chemical reduction of the oxidized form graphene oxide (GO).

The Applicant Directa Plus S.p.A. is the holder of patents and patent applications relating to production methods of structures comprising layers of graphene, such as EP 2 038 209 B1, WO 2014/135455 A1 and WO 2015/193267 A1. The last two patent applications cited describe production methods of pristine graphene dispersions, from which it is possible to obtain graphene nano-platelets with the dimension required for implementation of the present invention, and with a C/O ratio ≥100:1. This ratio is important as it defines the maximum amount of oxygen bonded to the carbon forming the graphene. In fact, the best properties of graphene, which derive from its high crystallographic quality, are obtained when the amount of oxygen is minimum.

A pristine graphene, i.e., with a C/O ratio ≥100, and having the size characteristics defined previously, is produced and marketed by Directa Plus S.p.A. with the trade name G+®.

The C/O ratio in the graphene used in the textile article according to the invention is determined by means of elemental analysis performed by elemental analyzer (CHNS O), which provides the percentage by weight of the various elements. The C/O ratio is obtained by normalizing the values obtained with respect to the atomic weight of the C and O species and finding their ratio.

When a more accurate determination is necessary, the C/O ratio is determined by using the Transmission Electron Microscopy (TEM) combined with the Energy-Dispersive X-ray Spectroscopy (TEM-EDX, also called TEM-EDS). This is a combination of two effective techniques, as with TEM, the microscopic surface structures of the sample can be seen with high precision and more closely than with a traditional light microscope. An EDX detector attached to the TEM microscope identifies the elements in the sample along with determining their concentrations and distribution. This allows an accurate determination of C and O.

It was found that graphene in oxidized form, just as that in the form obtained through reduction of graphene oxide (GO), has different characteristics and properties to pristine graphene. For example, the electrical and thermal conductivity properties and the mechanical strength properties of pristine graphene are superior to those of GO and to the reduction product obtained therefrom, also due to the presence of numerous lattice defects and imperfections of the crystalline structure caused by the reduction reaction.

The lattice defects of the nano-platelets can be evaluated by Raman spectroscopy analyzing intensity and shape of the D Peak positioned at 1350 cm⁻¹.

According to embodiments described in the patent documents mentioned above by the Applicant Directa Plus S.p.A., the process for producing pristine graphene is carried out continuously feeding graphite flakes to the high temperature expansion step, continuously discharging the expanded graphite thus obtained in an aqueous medium and continuously subjecting the expanded graphite dispersed in the aqueous medium to exfoliation and size reduction treatment carried out with ultrasonication and/or high pressure homogenization methods.

As described in these patent documents, the final dispersion of graphene nano-platelets obtained can be concentrated or dried, according to the final form desired for the graphene.

The purpose of drying the dispersion is to obtain a dry powder that is easily re-dispersible in various matrices, both solvents and polymers, where liquid is not desirable or manageable at process level, or where water cannot be used due to chemical incompatibility.

A significant advantage of the production processes described in the patent documents WO 2014/135455 A1 and WO 2015/193267 A1 consists in the possibility of operating without using surfactants. In fact, the graphene nano-platelets thus obtained are highly pristine, both due to the high C/O ratio and to the absence of extraneous substances, such as surfactants, which could contaminate them. In fact, it was found that in the absence of surfactants it is possible to obtain graphene having an electrical conductivity substantially higher than that of graphene obtained with processes using surfactants. This improves the performance of graphene in a plurality of applications.

Pristine graphene nano-platelets, at least 90% of which have a lateral dimension (x, y) from 50 to 50000 nm and a thickness (z) from 0.34 to 50 nm, with a C/O ratio ≥100:1, have a high electrical conductivity. It was also seen that when a dispersion of graphene nano-platelets is formed in the presence of a surfactant, this deposits on the surface thereof and tends to promote its tangling.

In the present description, the dimensions of the graphene nano-platelets are defined with reference to a system of Cartesian axes x, y, z, it being understood that the particles are substantially flat platelets but can also have an irregular shape. In any case, the lateral dimension and the thickness provided with reference to the directions x, y and z are meant as the maximum dimensions in each of the aforesaid directions.

The structural characterization of graphene can be made with the test method ISO/TS 21356-1, 202103.

The structural characterization of graphene incorporated in the composition of the invention can be made by separating the graphene from the binder, as well as from any other component of the composition, with methods known to a skilled person.

In the concentrated final dispersion or in the dry form obtained after drying, at least 90% of the graphene nano-platelets preferably have a lateral dimension (x, y) from 100 to 50000 nm and a thickness (Z) from 0.34 to 50 nm, and a C/O ratio ≥100:1. Preferably, at least 90% of the graphene nano-platelets have a lateral dimension (x, y) from 200 to 10000 nm and a thickness (z) from 0.34 to 10 nm, more preferably a lateral dimension (x, y) from 500 to 8000 nm, and even more preferably from 500 to 5000 nm, and preferably a thickness (z) from 0.34 to 8 nm, more preferably from 0.34 to 5 nm.

The graphene nano-platelets, hereinafter also referred to as GNPs, having the aforesaid properties of dimension and purity, thus having a very low oxygen content, as defined by the aforesaid C/O ratio and not functionalized with other molecules, proved to be particularly suitable for application to a textile substrate to obtain a textile article having excellent filtering and antibacterial properties.

### Methods of Applying the Graphene to the Textile Substrate

Various methods can be used to apply the composition comprising graphene to the textile substrate, such as full coating of the substrate, impregnation of the substrate and spray coating of the substrate.

The composition is preferably prepared by dispersing the polysaccharide binder in water in a receptacle stirred with a rotary blade stirrer, into which the graphene, and optionally the natural phytotherapeutic substance, are subsequently added. The composition is stirred until a uniform dispersion is obtained. Typically, stirring is carried out at a rotation speed of the stirrer ranging from 1000 to 2500 rpm for a time from 1 to 2 hours.

The textile article treated the fabric is then placed in an oven and heated to a temperature ranging from 120 to 180° C. for a time ranging from 1 to 10 minutes. The heat treatment causes evaporation of the water and fixing of the polymeric binder and of the other components, and hardening of the composition.

The textile article thus obtained can then be advantageously used to produce filtering manufactured products.

### Impregnation

This method consists in impregnation of the textile substrate in a bath containing graphene in the form of dispersed GNPs. The method allows the GNPs to be deposited not only on the surface of the textile substrate but also between the inner fibers.

Application consists in immersing the textile substrate in an impregnation tank. The fabrics are moved using rollers. After impregnation, the fabric is passed between two rubber coated rollers to eliminate the excess liquid. Subsequently, the fabric is fed through the oven at 150° C. for 3 minutes to fix the binder. If necessary, a further impregnation step is carried out and the fabric is then fed through the oven again at 150° C. for 3 minutes.

### Spray Coating

The method consists in spraying a dispersion of graphene and binder onto the textile substrate to obtain a light and uniform coating.

As indicated also by the following examples, the invention makes it possible to use textile substrates with normal or low antibacterial filtering efficiency in textile articles with high antibacterial filtering efficiency by the application of graphene in the amounts described. The pressure drop through the textile article thus obtained is limited, meaning that the article can be used effectively as filtering element, or can be used for the manufacture of filtering manufactured products. In the case of filtering manufactured products for individual health protection, such as face masks and the like, the manufactured product allows normal breathing.

The examples below illustrate some embodiments of the invention and are provided by way of non-limiting example.

### EXAMPLES

The graphene used in the following examples consists of pristine graphene nano-platelets, i.e., with a C/O ratio ≥100, and having the following dimensional properties: thickness (z) ranging from 0.34 to 10 nm and lateral dimensions (x, y) ranging from 400 to 5000 nm. This graphene is produced and marketed by Directa Plus S.p.A. with the tradename G+®, for brevity hereinafter also referred to as “G+”.

The compositions were prepared by dispersing the binder and the graphene in water by stirring.

The viscosity was measured according to the standard ISO 2555/1652 using a Fungilab series Viscolead PRO rotational Viscometer, R6 impeller speed 10 rpm. T=20° C.

Surface electrical resistivity: method JIS K 7194, instrument Loresta-GX MCP-T700.

Color fastness to rubbing: method UNI EN ISO 105-A03; instrument Crockmeter SDL ATLAS. Low color fastness=1; high color fastness=5

### Examples 1-4

Four compositions were prepared consisting of dispersions in water of Pure G+ graphene at the fixed concentration of 1.5% by weight, with binder consisting of the following polysaccharides: pectin, starch, sodium alginate and chitosan.

The examples were aimed at verifying the printability of the composition and the fixability of the graphene to the textile substrate, expressed as color fastness of the textile article to rubbing,

### Example 1

Water 240 g
Pectin 10 g (4%)
Graphene G+ 3.75 g (1.5%)

Viscosity 1025 cP.

### Example 2

Water 240 g
Corn starch Ultratex, (Special Ingredients Ltd, UK) 10 g (4%)
Graphene G+ 3.75 g (1.5%)

Viscosity: 6523 cP

### Example 3

Water 180 g
Sodium alginate 5 g (2%)
Graphene G+ 3.75 g (1.5%)

Viscosity: 5861 cP

### Example 4

Water 240 g
Acetic acid 2 g
Chitosan 10 g (4%)
Graphene G+ 3.75 g (1.5%)

Viscosity: 4682 cP

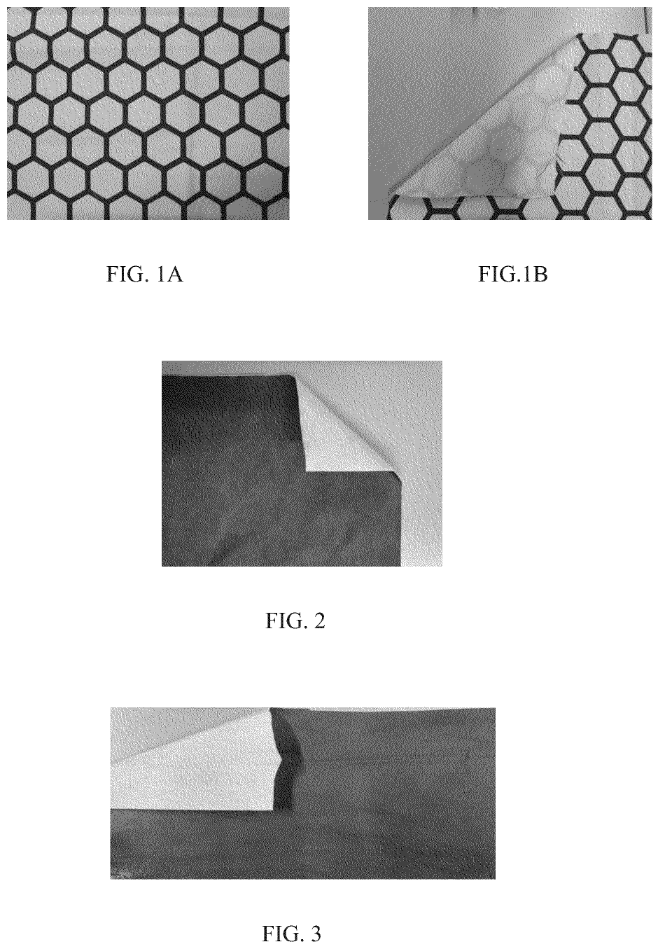

Four printing pastes were obtained, which were printed with a hexagonal pattern as shown in FIGS. 1A and 1B, on a polyester-cotton fabric subsequently treated at 150° C. for 3 minutes. After complete drying, surface resistivity and color fastness to rubbing were measured. The results are set down in Table 1 below.

TABLE 1

| | | Viscosity | Surface | Color fastness to |
|---|---|---|---|---|
| Example | Binder | (cP) | resistivity (Ω/□) | dry rubbing |
| 1 | Pectin | 1025 | 4.49 · 10⁹ | 4 |
| 2 | Starch | 6523 | 2.16 · 10⁹ | 2/3 |
| 3 | Sodium | 5861 | 8.36 · 10⁹ | 2/3 |
| | alginate | | | |
| 4 | chitosan | 4682 | 5.90 · 10⁹ | 4 |

The resistivity of the fabrics of all of Examples 1˜4 was in the order of 109 ohm, indicating that the fabric had acquired antistatic properties.

The dry color fastness was adequate.

Examples 1˜4 are useful to identify a composition having the relative amounts of graphene and binder adapted to confer a good electrical conductivity, expressed as surface resistivity upon the textile article to which the composition is applied. The relevant parameter is defined as percolation threshold, which expresses the percentage of conductive additive, i.e., of graphene, required to produce a conductive lattice that transforms the textile article, insulating by nature, into conductive.

The examples showed that the amount of graphene of 1.5% allows the textile article to become antistatic but not a good conductor due to failure to reach the percolation threshold.

### Examples 5-7

Three compositions were prepared consisting of dispersions in water of Pure G+ graphene at various concentrations, with binder consisting of starch at different concentrations.

### Example 5

Water 235 g
Corn starch Ultratex, (Special Ingredients Ltd, UK) 10 g (4%)
Graphene G+ 5 g (2%)

Viscosity 7735 cP.

### Example 6

Water 230 g
Corn starch Ultratex, (Special Ingredients Ltd, UK) 10 g (4%)
Graphene G+ 10 g (4%)

Viscosity: 5906 cP

### Example 7

Water 227.5 g
Corn starch Ultratex, (Special Ingredients Ltd, UK) 12.5 g
Graphene G+ 10 g (4%)

Viscosity: 9978 cP

Four printing pastes were obtained, which were printed with a hexagonal pattern as shown in FIGS. 1A and 1B, on a polyester-cotton fabric subsequently treated at 150° C. for 3 minutes. After complete drying, surface resistivity and color fastness to rubbing were measured. The results are set down in Table 2 below.

TABLE 2

| | | Viscosity | Surface | Color fastness to |
|---|---|---|---|---|
| Example | Binder | (cP) | resistivity (Ω/□) | dry rubbing |
| 5 | Starch | 7735 | 6.58 · 10⁶ | 3 |
| 6 | Starch | 5906 | 6.75 · 10³ | 3 |
| 7 | Starch | 9978 | 3.38 · 10³ | 3 |

The resistivity of the fabrics of all of Examples 5-7 indicated that the fabric had acquired highly antistatic to conductive properties.

The dry color fastness was adequate.

### Examples 8-10

Three compositions were prepared consisting of dispersions in water of Pure G+ graphene at various concentrations, with binder consisting of chitosan at different concentrations. Acetic acid was used to promote solubilization of the chitosan.

### Example 8

Water 230 g
Acetic acid 5 g (2%)
Chitosan 10 g (4%)
Graphene G+ 5 g (2%)

Viscosity 6650 cP.

### Example 9

Water 225 g
Acetic acid 2 g (1%)
Chitosan 10 g (4%)
Graphene G+ 10 g (4%)

Viscosity: 7892 cP

### Example 10

Water 225 g
Acetic acid 1 g (0.5%)
Chitosan 15 g (6%)
Graphene G+ 10 g (4%)

Viscosity: 8586 cP

Three printing pastes were obtained, which were printed with a hexagonal pattern as shown in FIGS. 1A and 1B, on a polyester-cotton fabric subsequently treated at 150° C. for 3 minutes. After complete drying, surface resistivity and color fastness to rubbing were measured. The results are set down in Table 3 below.

TABLE 3

| | | Viscosity | Surface | Color fastness to |
|---|---|---|---|---|
| Example | Binder | (cP) | resistivity (Ω/□) | dry rubbing |
| 8 | Chitosan | 6650 | 6.38 · 10⁹ | 4 |
| 9 | Chitosan | 7892 | 7.79 · 10⁵ | 4 |
| 10 | Chitosan | 8586 | 8.89 · 10⁴ | 3/4 |

The resistivity of the fabrics of Examples 9-10 indicated that the fabric had acquired conductive properties, while Example 8 had acquired antistatic properties.

The dry color fastness was adequate.

### Examples 11-13

Three compositions were prepared consisting of dispersions in water of Pure G+ graphene at various concentrations, with binder consisting of pectin at different concentrations.

### Example 11

Water 235 g
Pectin 10 g (4%)
Graphene G+ 5 g (2%)

Viscosity 1021 cP.

### Example 12

Water 230 g
Pectin 10 g (4%)
Graphene G+ 10 g (4%)

Viscosity: 1520 cP

### Example 13

Water 227.5 g
Pectin 12.5 g (5%)
Graphene G+10 g (4%)

Viscosity: 3491 cP

Three printing pastes were obtained, which were printed with a hexagonal pattern as shown in FIGS. 1A and 1B, on a polyester-cotton fabric subsequently treated at 150° C. for 3 minutes.

After complete drying, surface resistivity and color fastness to rubbing were measured. The results are set down in Table 4 below.

TABLE 4

| | | Viscosity | Surface | Color fastness to |
|---|---|---|---|---|
| Example | Binder | (cP) | resistivity (Ω/□) | dry rubbing |
| 11 | Pectin | 1021 | 3.20 · 10⁸ | 3/4 |
| 12 | Pectin | 1520 | 2.47 · 10⁴ | 3 |
| 13 | Pectin | 3491 | 7.09 · 10⁴ | 3 |

The resistivity of the fabric of Example 11 indicates antistatic properties, while Examples 12 and 13 indicate that the fabric had acquired conductive properties.

### Examples 14-16

Three compositions were prepared consisting of dispersions in water of Pure G+ graphene at various concentrations, with binder consisting of sodium alginate at different concentrations.

### Example 14

Water 240 g
Sodium alginate 5 g (2%)
Graphene G+ 5 g (2%)

Viscosity 6204 cP.

### Example 15

Water 230 g
Sodium alginate 5 g (2%)
Graphene G+ 10 g (4%)

Viscosity: 10414 cP

### Example 16

Water 230 g
Sodium alginate 10 g (4%)
Graphene G+ 10 g (4%)

Viscosity: 98200 cP

Three printing pastes were obtained, which were printed with a hexagonal pattern as shown in FIGS. 1A and 1B, on a polyester-cotton fabric subsequently treated at 150° C. for 3 minutes. After complete drying, surface resistivity and color fastness to rubbing were measured. The results are set down in Table 5 below.

TABLE 5

| | | Viscosity | Surface | Color fastness to |
|---|---|---|---|---|
| Example | Binder | (cP) | resistivity (Ω/□) | dry rubbing |
| 14 | Sodium | 6204 | 9.78 · 10⁹ | 3 |
| | alginate | | | |
| 15 | Sodium | 10414 | 1.17 · 10⁴ | 3 |
| | alginate | | | |
| 16 | Sodium | 98200 | 3.90 · 10⁵ | 3 |
| | alginate | | | |

The resistivity of the fabrics of all of Examples 15-16 indicated that the fabric had acquired conductive properties, while the fabric of Example 14 had acquired antistatic properties.

The dry color fastness was adequate.

### Examples 17-19

Three compositions were prepared consisting of dispersions in water of Pure G+ graphene at the fixed concentration of 4% by weight, with binder consisting of the following polysaccharides: pectin, starch, sodium alginate.

The examples were aimed at preparing filters for face masks composed entirely of materials obtained from renewable sources.

### Example 17

Water 230 g
Pectin 10 g (4%)
Graphene G+ 10 g (4%)

### Example 18

Water 230 g
Sodium alginate 5 g (2%)
Graphene G+ 10 g (4%)

### Example 19

Water 230 g
Corn starch Ultratex, (Special Ingredients Ltd, UK) 10 g (4%)
Graphene G+ 10 g (4%)

### Example 20

Water 225 g
Acetic acid 2 g (1%)
Chitosan 10 g (4%)
Graphene G+ 10 g (4%)

Three printing pastes were obtained, which were printed on the whole of the surface of a three-layer nonwoven consisting of a layer of cellulose pulp inserted between two layers of bamboo viscose. Each layer of bamboo viscose had a basis weight of 55 g/m², the layer of cellulose pulp had a basis weight of 90 g/m² and the nonwoven as a whole had a basis weight of 200 g/m². After printing the nonwoven was treated at 150° ° C. for 3 minutes. After complete drying, surface resistivity, airflow resistance, bacterial filtration and antibacterial activity were measured.

The textile article obtained after treatment with the composition of Example 18 is shown in FIG. 2.

The pressure drop (ΔP) through the textile article was measured as breathability according to the standard UNI EN 14683:2019.

The surface electrical resistivity was measured with the method JIS K 7194, instrument Loresta-GX MCP-T700.

The Bacterial Filtration Efficiency (BFE) was measured with the method UNI EN 14683 Annex B (Chapter 5 Paragraph 2.2)

The antibacterial activity was determined with the method UNI EN ISO 20743:2013, which evaluates antibacterial activity expressed in percentage.

The results are set down in Table 6 below.

TABLE 6

| | | | Surface | | |
|---|---|---|---|---|---|
| Exam- | | ΔP | resistivity | BFE | Antibacterial |
| ple | Binder | (Pa/cm²) | (Ω/□) | % | activity |
| 17 | Pectin | 28.9 | 1.21 · 10⁴ | N/A | N/A |
| 18 | Sodium | 26.7 | 1.48 · 10³ | 86.3 | N/A |
| | alginate | | | | |
| 19 | Starch | 30.2 | 1.01 · 10³ | N/A | N/A |
| 20 | Chitosan | 33.7 | 2.22 · 10⁴ | 93.3 | Klebsiella |
| | | | | | Pneumoniae = |
| | | | | | 100% |
| | | | | | Staphylococcus |
| | | | | | aureus = 99.998% |

The resistivity of the textile article of all the Examples 17-20 is indicative that the fabric had acquired good conductivity.

The pressure drop values showed excellent filtering capacity and good respiratory efficiency.

The textile articles treated with sodium alginate and chitosan showed excellent bacterial filtration capacity.

The textile article treated with chitosan showed excellent antibacterial activity.

### Example 21

Example 20 was repeated but with a composition also comprising 5 g of curcumin.
Water 225 g
Acetic acid 2 g (1%)
Chitosan 10 g (4%)
Curcumin 5 g (2%)
Graphene G+ 10 g (4%)

The textile article obtained after treatment with the composition of Example 21 is shown in FIG. 3.

The results of the measurements are set down in Table 7 below.

TABLE 7

| | Binder/ | | Surface | | |
|---|---|---|---|---|---|
| | phyto- | | resis- | | Anti- |
| Exam- | therapeutic | ΔP | tivity | BFE | bacterial |
| ple | substance | (Pa/cm²) | (Ω/□) | % | activity |
| 21 | Chitosan/ | 39.9 | 5.33 · 10⁵ | 80.76% | Klebsiella |
| | curcumin | | | | Pneumoniae |
| | | | | | 100% |
| | | | | | Staphylococcus |
| | | | | | aureus 100% |

The resistivity of the textile article is indicative that the fabric had acquired good conductivity.

The pressure drop value showed excellent filtering capacity and good respiratory efficiency.

The bacterial filtration capacity was high (80.76%).

The textile article treated with curcumin in addition to graphene showed excellent antibacterial activity.

1-9. (canceled)

10. A composition for treatment of textile articles, the composition comprising graphene and a binding agent dispersed in an aqueous medium, wherein the binding agent is a polysaccharide selected from among starch, glycogen, chitosan, pectin, salts of alginic acid or alginates, dextran, chitin, glycans, and combinations thereof.

11. The composition of claim 10, wherein the composition is an aqueous dispersion which comprises:
between 0.5 and 20% by weight of graphene; and
between 1.0 and 50% by weight of the polysaccharide.

12. The composition of claim 10, further comprising a natural phytotherapeutic substance with an inhibitory effect on SARS-CoV-2 infection.

13. The composition of claim 12, wherein the natural phytotherapeutic substance is selected from among curcumin, emodin, α-hederine, thymoquinone, and combinations thereof.

14. The composition of claim 10, wherein the graphene comprises graphene nano-platelets in which at least 90% has a lateral dimension (x, y) between 100 and 50000 nm and a thickness (z) between 0.34 and 50 nm.

15. The composition of claim 10, wherein the graphene has a carbon-to-oxygen (C/O) ratio of ≥100:1.

16. A textile article comprising graphene in an amount of 0.5 to 20 g per square meter of textile substrate, and a binder comprising a polysaccharide in an amount of 0.5 to 50 g per square meter of textile substrate, wherein the polysaccharide being selected from among starch, glycogen, chitosan, pectin, salts of alginic acid or alginates, dextran, chitin, glycans, and combinations thereof.

17. The textile article of claim 16, comprising a natural phytotherapeutic substance with an inhibitory effect on SARS-CoV-2 infection.

18. The textile article of claim 17, wherein the natural phytotherapeutic substance is selected from among curcumin, emodin, α-hederine, thymoquinone, and combinations thereof, and has a bacterial filtration efficiency higher than 80% according to the standard UNI EN 14683: 2019 Annex B.

19. The textile article of claim 16, wherein the graphene comprises graphene nano-platelets in which at least 90% has a lateral dimension (x, y) between 100 and 50000 nm and a thickness (z) between 0.34 and 50 nm.

20. The textile article of claim 16, wherein the graphene has a carbon-to-oxygen (C/O) ratio of ≥100:1.
